(19) United States
(12) Patent Application Publication
(10) Pub. No.: US 2026/0268701 A1
(43) Pub. Date: Sep. 10, 2026

(54) DOCUMENT STRUCTURE INFORMATION EXTRACTING AND DOCUMENT MERGING APPARATUS USING ARTIFICIAL INTELLIGENCE

(71) Applicant: ALLBIGDAT INC., Seongnam-si, Gyeonggi-do (KR)

(72) Inventors: Dong Jae LEE, Seongnam-si, Gyeonggi-do (KR); Ji Woo KWAK, Seongnam-si, Gyeonggi-do (KR)

(73) Assignees: ALLBIGDAT INC., Seongnam-si, Gyeonggi-do (KR); ALLBIGDAT INC., Seongnam-si, Gyeonggi-do (KR)

(21) Appl. No.: 18/876,215

(22) PCT Filed: Oct. 27, 2023
(86) PCT No.: PCT/KR2023/016902

§ 371 Date: Dec. 18, 2024

(30) Foreign Application Priority Data
Mar. 24, 2023 (KR) 10-2023-0038693

(51) Int. Cl. G06V 30/416; G06F 40/174; G06V 10/74; G06V 10/764; G06V 30/19; G06V 30/244; G06V 30/418

(52) U.S. Cl. CPC G06V 30/416; G06F 40/174; G06V 10/761; G06V 10/764; G06V 30/19093; G06V 30/19173; G06V 30/245; G06V 30/418

(57) ABSTRACT

A device for extracting document structure information and merging documents using artificial intelligence (AI) that extracts structural information of a plurality of documents from style information of characters constituting the documents and generates a new document by merging the documents from which the structural information is extracted, includes a document image receiving unit, a letter recognizing unit, a paragraph recognizing unit, and a paragraph attribute determining unit.

### TECHNICAL FIELD

The present invention relates to a device for extracting document structure information and merging documents using artificial intelligence (AI), and more particularly, to a device for extracting document structure information and merging documents using AI which determines attributes of characters using the AI, identifies document structure information from the attributes of the characters, and consolidates a plurality of documents into a single document on the basis of the document structure information to generate a new document.

### BACKGROUND ART

The rapid development of artificial intelligence (AI) has led to it being actively used in various industries.

Such development of AI is leading to a variety of automation in the field of office automation. In particular, significant efforts are being made to recognize and datafy printed content, and a representative example is a related study for combining natural language processing models, such as bidirectional encoder representations from transformers (BERT) and the like, with optical character recognition technology to correct recognition results.

According to methods developed to date, characters are recognized and classified on the basis of rules conceptually defined by humans and dictionaries. Accordingly, it is difficult to apply a differential analysis method in accordance with the difference in document components, and it is necessary to develop a technology for realizing the relationship between a data structure and text data included in a target document.

The background art of the present invention is disclosed in Korean Patent No. 10-2388781.

### DISCLOSURE

### Technical Problem

The present invention is directed to providing a device for extracting document structure information and merging documents using artificial intelligence (AI), more particularly, a device for extracting document structure information and merging documents using AI that determines attributes of characters using the AI, identifies document structure information from the attributes of characters, and consolidates a plurality of documents into a single document on the basis of the document structure information to generate a new document.

### Technical Solution

One aspect of the present invention provides a device for extracting document structure information and merging documents using artificial intelligence (AI) that extracts structural information of a plurality of documents from style information of characters constituting the documents and generates a new document by merging the documents from which the structural information is extracted, the device including a document image reception unit configured to receive document images from a user terminal used by a user, a character recognition unit configured to recognize characters included in the document images by applying optical character recognition (OCR) to the received document images, a paragraph recognition unit configured to recognize paragraphs on the basis of top-bottom intervals of the characters recognized from the received document images, and a paragraph attribute determination unit configured to analyze positions of the recognized paragraphs and a style of the characters constituting the paragraphs through an AI model, which utilizes data of a plurality of documents as training data, and determine attributes of the paragraphs. The style of the characters includes information about a size, a slant, a color, and a font, and the attributes of the paragraphs include information about functions of the paragraphs.

The device for extracting document structure information and merging documents using AI may further include a document type determination unit configured to determine types of documents composed of the paragraphs on the basis of the determined attributes of the paragraphs, and the paragraph attribute determination unit may determine the attributes of the recognized paragraphs as one of title, subtitle, introduction, body, and conclusion.

The device for extracting document structure information and merging documents using AI may further include a merging request signal reception unit configured to receive a merging request signal, which is a signal for requesting merging of a first document image and a second document image selected from among the document images received by the document image reception unit, from the user terminal, a document type comparison unit configured to compare a document type determined from the first document image with a document type determined from the second document image when the merging request signal is generated, generate an identicalness signal when the two document types are the same, and generate a non-identicalness signal when the two document types are different, a keyword similarity calculation unit configured to extract a keyword included in a title paragraph of the first document image and a keyword included in a title paragraph of the second document image when the identicalness signal is generated, and calculate a keyword similarity by determining whether the extracted keywords overlap, and a merging impossibility signal transmission unit configured to generate a merging impossibility signal and transmit the merging impossibility signal to the user terminal when the calculated keyword similarity is less than a set value or the non-identicalness signal is generated. The keyword similarity calculation unit may extract the keywords included in the title paragraphs of the first document image and the second document image through an AI model that learns data of a plurality of paragraphs from which the keywords are extracted.

The device for extracting document structure information and merging documents using AI may further include a merging possibility signal transmission unit configured to extract words included in the body paragraphs of the first document image and the second document image when the calculated keyword similarity is the set value or more, classify the extracted words in descending order of frequency, and generate a merging possibility signal and transmit the merging possibility signal to the user terminal when words at a set ranking or higher overlap between the two document images by a set ratio or more. The merging impossibility signal transmission unit may generate the merging impossibility signal and transmit the merging impossibility signal to the user terminal when the words at the set ranking or higher overlap between the two document images by less than the set ratio.

The device for extracting document structure information and merging documents using AI may further include a preceding-and-following relationship determination unit configured to extract phrases or words representing time points from paragraphs of each of the first document image and the second document image when the merging possibility signal is generated, and determine a temporal preceding-and-following relationship of the first document image and the second document image from the extracted phrases or words, a title paragraph determination unit configured to determine the title paragraph of a document image of a following time point between the first document image and the second document image as a title paragraph of the merged new document on the basis of the preceding-and-following relationship determined by the preceding-and-following relationship determination unit, and a subtitle paragraph determination unit configured to determine the title paragraph of a document image of a preceding time point between the first document image and the second document image as a subtitle paragraph of the merged new document on the basis of the preceding-and-following relationship determined by the preceding-and-following relationship determination unit. The preceding-and-following relationship determination unit may determine the temporal preceding-and-following relationship by applying an AI model that learns document data including phrases, conjunctions, and words representing time points to the paragraphs of each of the first document image and the second document image.

The device for extracting document structure information and merging documents using AI may further include an introductory paragraph determination unit configured to determine an introductory paragraph of the merged new document by connecting the introductory paragraph of the document image of the preceding time point between the first document image and the second document image and the introductory paragraph of the document image of the following time point on the basis of the preceding-and-following relationship determined by the preceding-and-following relationship determination unit, a body paragraph determination unit configured to determine a body paragraph of the merged new document by connecting the body paragraph of the document image of the preceding time point between the first document image and the second document image and the body paragraph of the document image of the following time point on the basis of the preceding-and-following relationship determined by the preceding-and-following relationship determination unit, and a conclusive paragraph determination unit configured to determine the conclusive paragraph of the document image of the following time point as a conclusive paragraph of the merged new document on the basis of the preceding-and-following relationship determined by the preceding-and-following relationship determination unit. The body paragraph determination unit may determine a connective phrase of the body paragraph of the first document image and the body paragraph of the second document through an AI model that learns data of a plurality of sentences connected in a causal relationship, and may connect the two paragraphs using the determined connective phrase.

The device for extracting document structure information and merging documents using AI may further include a sentence deletion unit configured to specify subjects, objects, and predicates of sentences included in the introductory paragraphs and body paragraphs determined by the introductory paragraph determination unit and the body paragraph determination unit, and when a plurality of sentences have specific similar subjects, objects, and predicates, delete the plurality of sentences except for a sentence with a longest length of characters, and a new document data transmission unit configured to generate new document data in which the first document image and the second document image are merged by merging the paragraphs determined by the title paragraph determination unit, the subtitle paragraph determination unit, the introductory paragraph determination unit, the body paragraph determination unit, the conclusive paragraph determination unit, and the sentence deletion unit, distinguishably mark sentences generated from the first document image and characters generated from the second document image in the generated new document data, and transmit the generated new document data to the user terminal.

### Advantageous Effects

According to the present invention, it is possible to recognize paragraphs by analyzing a given document image through an artificial intelligence (AI) model and identify attributes of each of the recognized paragraphs and the type of document.

According to the present invention, when merging of document images is requested, the two document images are analyzed to thoroughly determine whether the two documents can be merged together. When it is determined that the two documents can be merged together, the preceding-and-following relationship of the two documents is determined, and a new document is generated by merging the two documents in consideration of the determined preceding-following relationship. A user can obtain a document in which the two documents are naturally merged by partially modifying the generated document.

### DESCRIPTION OF DRAWINGS

FIG. 1 is a block diagram of a system for extracting document structure information and merging documents according to an embodiment of the present invention.

FIG. 2 is a block diagram of a device for extracting document structure information and merging documents according to an embodiment of the present invention.

FIG. 3 is a block diagram of a paragraph determination unit according to an embodiment of the present invention.

### BEST MODE OF THE INVENTION

A device for extracting document structure information and merging documents using artificial intelligence (AI) that extracts structural information of a plurality of documents from style information of characters constituting the documents and generates a new document by merging the documents from which the structural information is extracted, includes a document image reception unit configured to receive document images from a user terminal used by a user, a character recognition unit configured to recognize characters included in the document images by applying optical character recognition (OCR) to the received document images, a paragraph recognition unit configured to recognize paragraphs on the basis of top-bottom intervals of the characters recognized from the received document images, and a paragraph attribute determination unit configured to analyze positions of the recognized paragraphs and a style of characters constituting the paragraphs through a machine learning algorithm, in which data of a plurality of documents is utilized as training data, and determine attributes of the paragraphs. The style of the characters includes information about a size, a slant, and a color, and the attributes of the paragraphs include information about functions of the paragraphs.

### Modes of the Invention

Hereinafter, exemplary embodiments of the present invention will be described in detail such that those skilled in the technical field to which the present invention pertains can readily implement the present invention with reference to the accompanying drawings. However, the present invention can be implemented in a variety of different forms and is not limited to embodiments described herein. To clearly describe the present invention, parts irrelevant to the description will be omitted from the drawings, and throughout the specification, like reference numerals refer to like elements.

In the specification, when a part is referred to as being “connected to” another part, the parts may be “directly connected to” each other or “electrically connected to” each other with still another part interposed therebetween. Also, when a part is referred to as “including” a component, other components are not excluded but may be further included unless specifically stated otherwise. The present invention will be described in detail below with reference to the accompanying drawings.

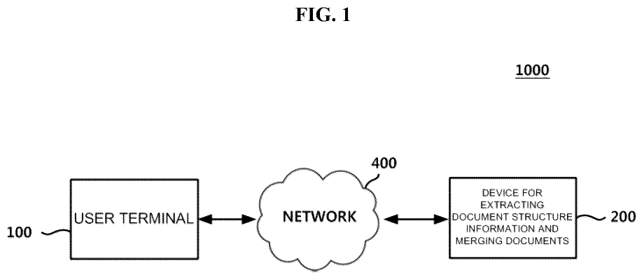

FIG. 1 is a block diagram of a system 1000 for extracting document structure information and merging documents according to an embodiment of the present invention.

Referring to FIG. 1, the system 1000 for extracting document structure information and merging documents according to the embodiment of the present invention may include a user terminal 100 and a device 200 for extracting document structure information and merging documents connected to the user terminal 100 via a network 400.

The user terminal 100 may be a terminal used by a person who wants to extract a structure from a document or merge documents. For example, the user may be a newspaper reporter, and in this case, the user may want to extract a document structure from another's article or generate a new article by merging two articles.

The user terminal 100 may be a smartphone. However, the user terminal 100 is not limited thereto and may include an electronic device such as a general desktop computer, a navigation device, a laptop computer, a digital broadcast terminal, a personal digital assistant (PDA), a portable multimedia player (PMP), a tablet personal computer (PC), or the like. The electronic device may have one or more general or special purpose processors, memories, storages, and/or (wired or wireless) networking components.

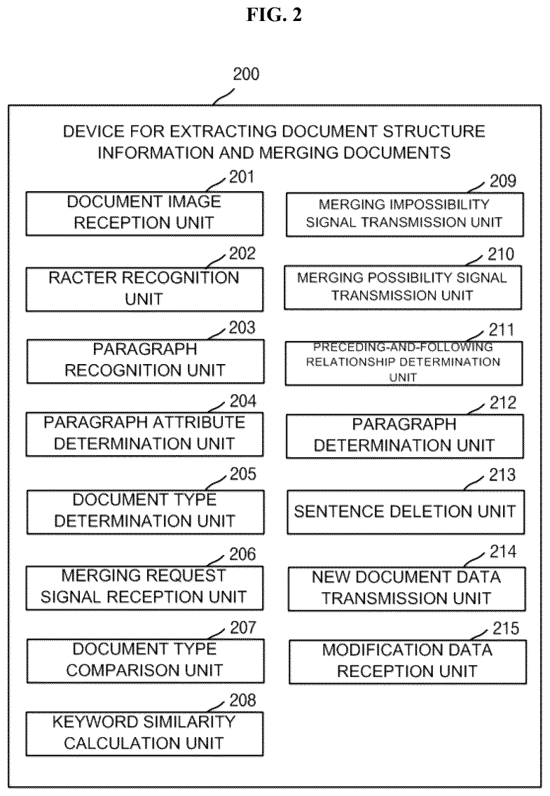

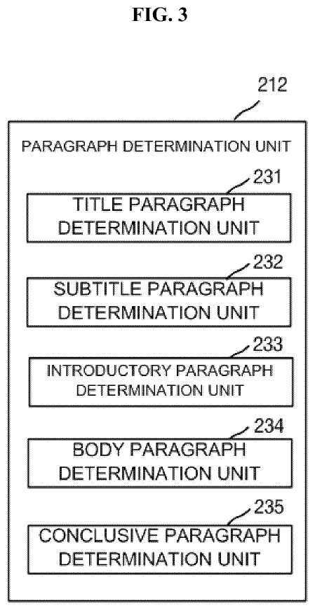

The device 200 for extracting document structure information and merging documents may receive document image data from the user terminal 100, analyze the document image data using artificial intelligence (AI) to determine attributes of paragraphs and the type of document, and merge a plurality of documents under a specific condition. The device 200 for extracting document structure information and merging documents may be a server and may be implemented in the form of an application in the user terminal 100. Details of the device 200 for extracting document structure information and merging documents will be described in further detail with reference to FIGS. 2 and 3.

The network 400 is not limited, and examples of communication networks that may be included in the network 400 include not only communication methods employing a mobile communication network, a wired online network, a wireless online network, and a broadcast network but also short-range wireless communication between devices. For example, the network 400 may include any one or more networks among a personal area network (PAN), a local area network (LAN), a campus area network (CAN), a metropolitan area network (MAN), a wide area network (WAN), a broadband network (BBN), an online network, and the like.

FIG. 2 is a block diagram of the device 200 for extracting document structure information and merging documents according to an embodiment of the present invention, and FIG. 3 is a block diagram of a paragraph determination unit 212 according to an embodiment of the present invention.

Referring to FIGS. 2 and 3, the device 200 for extracting document structure information and merging documents according to an embodiment of the present invention may include a document image reception unit 201, a character recognition unit 202, a paragraph recognition unit 203, a paragraph attribute determination unit 204, a document type determination unit 205, a merging request signal reception unit 206, a document type comparison unit 207, a keyword similarity calculation unit 208, a merging impossibility signal transmission unit 209, a merging possibility signal transmission unit 210, a preceding-and-following relationship determination unit 211, a paragraph determination unit 212, a sentence deletion unit 213, a new document data transmission unit 214, and a modification data reception unit 215.

The document image reception unit 201 may receive document images from the user terminal 100. The document images may be image files rather than text documents.

The character recognition unit 202 may recognize characters included in the received document images by applying optical character recognition (OCR) to the document images. However, a character recognition technology is not limited thereto, and the character recognition unit 202 may recognize the characters included in the document images by analyzing the document through not only OCR but also an AI deep learning model.

The paragraph recognition unit 203 may recognize paragraphs on the basis of top-bottom intervals of the characters recognized from the received document images.

The interval between paragraphs is generally larger than the interval between characters in one paragraph. On the basis of this, the paragraph recognition unit 203 may distinguish paragraphs in document images of which characters are recognized. However, the paragraph recognition unit 203 does not recognize paragraphs only depending on top-bottom intervals of characters and may distinguish paragraphs in document images in comprehensive consideration of the top-bottom intervals, indented first characters of paragraphs, and the like.

The paragraph attribute determination unit 204 may analyze positions of the recognized paragraphs and a style of the characters constituting the paragraphs through an AI model, which utilizes data of a plurality of documents as training data, and may determine attributes of the paragraphs.

The paragraph attribute determination unit 204 may learn the data of the plurality of documents provided by a manager through the AI model and analyze results of the learning, the positions of the recognized paragraphs, and the style of characters constituting the paragraphs to determine attributes of the paragraphs.

The style of the characters may include information about a size, a slant, and a color of the characters, and the attributes of the paragraphs may include information about functions of the paragraphs. For example, the paragraph attribute determination unit 204 may learn a size, a slant, a color, and a font of characters constituting a title through the AI model and detect a paragraph suited to the corresponding features from the recognized paragraphs to recognize the paragraph as a title paragraph. The capability of recognizing attributes of a paragraph may become more accurate when the amount of learning continuously accumulates.

The paragraph attribute determination unit 204 may determine types of documents composed of the paragraphs on the basis of the determined attributes of the paragraphs.

The document type determination unit 205 may determine the types of documents composed of the paragraphs on the basis of the determined attributes of the paragraphs. The document type determination unit 205 may learn the data of the plurality of documents provided by the manager through an AI model and determine the types of documents composed of the paragraphs of which the attributes are determined on the basis of results of the learning. For example, the document type determination unit 205 may learn a layout structure based on attributes of paragraphs constituting a newspaper article from document data of the newspaper article and determine whether a given document is a newspaper article on the basis of results of the learning. Types of documents may be manuals, essays, newspaper articles, reports, and the like. These documents may have different layout structures of paragraphs.

In this way, according to the present invention, it is possible to recognize paragraphs by analyzing a given document image through an AI model and determine attributes of each of the recognized paragraphs and a type of document.

The merging request signal reception unit 206 may receive a merging request signal, which is a signal for requesting merging of a first document image and a second document image selected from among the document images received by the document image reception unit 201, from the user terminal 100. A user may input two document images to the user terminal 100 as necessary and input a merging request signal to merge the document images. The input merging request signal may be transmitted to the merging request signal reception unit 206 through the user terminal 100.

The document type comparison unit 207 may compare a document type determined from the first document image with a document type determined from the second document image when the merging request signal is generated, may generate an identicalness signal when the two document types are the same, and may generate a non-identicalness signal when the two document types are different. The document type comparison unit 207 may compare the document type of the first document image and the document type of the second document image determined by the foregoing document type determination unit 205, may generate an identicalness signal when the two document types are the same, and may generate a non-identicalness signal when the two document types are not the same.

The keyword similarity calculation unit 208 may extract a keyword included in a title paragraph of the first document image and a keyword included in a title paragraph of the second document image when the identicalness signal is generated, and may calculate a keyword similarity by determining whether the extracted keywords overlap.

The keyword similarity calculation unit 208 may extract words which are determined as keywords from the title paragraphs of the document images through an AI model that extracts keywords from document data, compare the keywords extracted from the two document images, and calculate the keyword similarity on the basis of an overlapping ratio.

The merging impossibility signal transmission unit 209 may generate a merging impossibility signal and transmit the merging impossibility signal to the user terminal 100 when the calculated keyword similarity is less than a set value or the non-identicalness signal is generated.

When there are no overlapping words among keywords of the title paragraphs of the two document images, the keyword similarity may be less than the set value. In this case, the merging impossibility signal transmission unit 209 may determine that there is no content commonality between the two documents, and generate a merging impossibility signal. Also, when the document types of the two document images are not identical, paragraph layout structures of the two documents are completely different. In this case, when these documents are merged, there is a high probability that a document with very unnatural content will be generated. Accordingly, in this case, the merging impossibility signal transmission unit 209 may also generate a merging impossibility signal. For example, when the two documents are a newspaper article and an essay, the merging impossibility signal transmission unit 209 may generate a merging impossibility signal and transmit the merging impossibility signal to the user terminal 100 because characteristics of paragraph layout structures of the two documents are completely different.

The merging possibility signal transmission unit 210 may extract words included in body paragraphs of the first document image and the second document image when the calculated keyword similarity is the set value or more, may classify the extracted words in descending order of frequency, and may generate a merging possibility signal and transmit the merging possibility signal to the user terminal 100 when words at a set ranking or higher overlap between the two document images by a set ratio or more. In other words, when the keyword similarity between the two document images is the set value or more, the merging possibility signal transmission unit 210 may compare the bodies of the two documents and determine whether the two documents can ultimately be merged. Specifically, the merging possibility signal transmission unit 210 may extract the words included in the body paragraphs of each of the document images, classify the extracted words in descending order of frequency, and when words at the set ranking or higher overlap between the two document images by the set ratio or more, generate a merging possibility signal by considering that the two documents are of the same type and include similar contents in bodies thereof.

On the other hand, when the words at the set ranking or higher overlap between the two document images by less than the set ratio, the two document images are of the same type and have similar titles to some extent, but body contents are completely different. Accordingly, in this case, it is determined that merging the two documents is impossible, and the merging impossibility signal transmission unit 209 may generate a merging impossibility signal and transmit the merging impossibility signal to the user terminal 100.

A process of generating a merging possibility signal and merging two document images will be described in detail below.

When a merging possibility signal is generated, the preceding-and-following relationship determination unit 211 may extract phrases or words representing time points from paragraphs of each of the first document image and the second document image and determine a temporal preceding-and-following relationship of the first document image and the second document image from the phrases or words.

The preceding-and-following relationship determination unit 211 may determine the temporal preceding-and-following relationship by applying an AI model, which learns document data including phrases, conjunctions, and words that present time points, to paragraphs of the first document image and the second document image.

For example, when a clear time point is presented in the body of the first document image and results caused by the content of the first document image are disclosed in the second document image, the preceding-and-following relationship determination unit 211 may determine the preceding-and-following relationship by determining that the time point of the first document image precedes the time point of the second document image.

When the preceding-and-following relationship between the two document images is determined, a new document may be generated according to the present invention by determining title paragraphs, subtitle paragraphs, introductory paragraphs, body paragraphs, and conclusive paragraphs using the following method.

The paragraph determination unit 212 may include a title paragraph determination unit 231, a title paragraph determination unit 232, an introductory paragraph determination unit 233, a body paragraph determination unit 234, and a conclusive paragraph determination unit 235.

The title paragraph determination unit 231 may determine the title paragraph of a document image of the following time point between the first document image and the second document image as a title paragraph of the merged new document on the basis of the preceding-and-following relationship determined by the preceding-and-following relationship determination unit 211. This reflects the fact that content of a later time point is a final result and is more important than content of an earlier time point.

The subtitle paragraph determination unit 232 may determine the title paragraph of a document image of the preceding time point between the first document image and the second document image as a subtitle paragraph of the merged new document on the basis of the preceding-and-following relationship determined by the preceding-and-following relationship determination unit 211. Since the subtitle of the document should include content that supports the title, the subtitle paragraph may be regarded as a reflection of the title paragraph of the document image of the preceding time point which may support the title paragraph in consideration of the fact that the title paragraph of the document image of the following time point is determined as the title paragraph.

The introductory paragraph determination unit 233 may determine an introductory paragraph of the merged new document by connecting the introductory paragraph of the document image of the preceding time point between the first document image and the second document image and the introductory paragraph of the document image of the following time point on the basis of the preceding-and-following relationship determined by the preceding-and-following relationship determination unit 211. Since the introductory paragraph briefly introduces the subject matter prior to the body, the introduction of the merged document may be regarded as a reflection of both introductory paragraphs of the two documents.

The body paragraph determination unit 234 may determine a body paragraph of the merged new document by connecting the body paragraph of the document image of the preceding time point between the first document image and the second document image and the body paragraph of the document image of the following time point on the basis of the preceding-and-following relationship determined by the preceding-and-following relationship determination unit 211. Since the body paragraph should reflect all main content, both body paragraphs of the two documents are included, and the body of the document image of the preceding time point is disposed forward to naturally establish a causal relationship.

The body paragraph determination unit 234 may determine a connective phrase that naturally connects the body paragraph of the first document image and the body paragraph of the second document, through an AI model that learns data of a plurality of sentences connected in a causal relationship, and connect the two paragraphs using the determined connective phrase to reflect the connected paragraphs in body paragraphs of the merged new document.

The conclusive paragraph determination unit 235 may determine a conclusive paragraph of the document image of the following time point between the first document image and the second document image as the conclusive paragraph of the merged new document on the basis of the preceding-and-following relationship determined by the preceding-and-following relationship determination unit 211. Since the conclusive paragraph should reflect the content of a final conclusion, the conclusive paragraph of the document of the following time point between the two documents is reflected in the conclusive paragraph of the merged new document.

The sentence deletion unit 213 may specify subjects, objects, and predicates of sentences included in the introductory paragraphs and body paragraphs determined by the introductory paragraph determination unit 233 and the body paragraph determination unit 234, and when a plurality of sentences have specific similar subjects, objects, and predicates, may delete the plurality of sentences except for a sentence with the longest length of characters. Since overlapping sentences may exist in the process of merging the documents, the sentence deletion unit 213 may delete such overlapping sentences except for the longest sentence that is regarded as presenting more details.

The new document data transmission unit 214 may generate new document data in which the first document image and the second document image are merged, by merging the paragraphs determined by the title paragraph determination unit 231, the subtitle paragraph determination unit 232, the introductory paragraph determination unit 233, the body paragraph determination unit 234, the conclusive paragraph determination unit 235, and the sentence deletion unit 213, distinguishably mark sentences generated from the first document image and characters generated from the second document image in the generated new document data, and transmit the generated new document data to the user terminal 100.

The modification data reception unit 215 may receive modification data generated by the user checking the new document data and modifying sentences constituting the new document data, from the user terminal 100.

The user may check the new document data in which the sentences generated from the first document image and the sentences generated from the second document image are displayed and thus can view how the new document data has been merged. When there is a portion to be modified, the user may modify the portion in person through the user terminal 100 to ultimately obtain completed new document data.

In this way, according to the present invention, when there is a signal for requesting merging of document images, the two document images are analyzed to thoroughly determine whether the two documents can be merged, and when it is determined that the two documents can be merged, a preceding-and-following relationship of the two documents is determined and taken into consideration to generate a new document in which the two documents are merged. A user can obtain a document in which the two documents are naturally merged by partially modifying the generated document.

The above-described embodiments are illustrative, and those skilled in the technical field to which the above-described embodiments pertain should understand that the above-described embodiments can be easily modified into other detailed forms without changing the technical spirit or essential features of the above-described embodiments. Therefore, the above-described embodiments are exemplary in all aspects and should be understood as non-limiting. For example, each component described as singular may also be implemented in a distributed manner, and similarly, components described as distributed may also be implemented in a combined form.

The scope to be protected by this specification is indicated by the following claims rather than the detailed description and should be construed as including all altered or modified forms derived from the meaning and scope of the claims and the equivalents thereof.

1. A device for extracting document structure information and merging documents using artificial intelligence (AI) that extracts structural information of a plurality of documents from style information of characters constituting the documents and generates a new document by merging the documents from which the structural information is extracted, the device comprising:
a document image reception unit configured to receive document images from a user terminal used by a user;
a character recognition unit configured to recognize characters included in the document images by applying optical character recognition (OCR) to the received document images;
a paragraph recognition unit configured to recognize paragraphs on the basis of top-bottom intervals of the characters recognized from the received document images; and
a paragraph attribute determination unit configured to analyze positions of the recognized paragraphs and a style of the characters constituting the paragraphs through an AI model, which utilizes data of a plurality of documents as training data, and determine attributes of the paragraphs,
wherein the style of the characters includes information about a size, a slant, a color, and a font, and the attributes of the paragraphs include information about functions of the paragraphs.

2. The device of claim 1, further comprising a document type determination unit configured to determine types of documents composed of the paragraphs on the basis of the determined attributes of the paragraphs,
wherein the paragraph attribute determination unit determines the attributes of the recognized paragraphs as one of title, subtitle, introduction, body, and conclusion.

3. The device of claim 2, further comprising:
a merging request signal reception unit configured to receive a merging request signal, which is a signal for requesting merging of a first document image and a second document image selected from among the document images received by the document image reception unit, from the user terminal;
a document type comparison unit configured to compare a document type determined from the first document image with a document type determined from the second document image when the merging request signal is generated, generate an identicalness signal when the two document types are the same, and generate a non-identicalness signal when the two document types are different;
a keyword similarity calculation unit configured to extract a keyword included in a title paragraph of the first document image and a keyword included in a title paragraph of the second document image when the identicalness signal is generated, and calculate a keyword similarity by determining whether the extracted keywords overlap; and
a merging impossibility signal transmission unit configured to generate a merging impossibility signal and transmit the merging impossibility signal to the user terminal when the calculated keyword similarity is less than a set value or the non-identicalness signal is generated,
wherein the keyword similarity calculation unit extracts the keywords included in the title paragraphs of the first document image and the second document image through an AI model that learns data of a plurality of paragraphs from which the keywords are extracted.

4. The device of claim 3, further comprising a merging possibility signal transmission unit configured to extract words included in the body paragraphs of the first document image and the second document image when the calculated keyword similarity is the set value or more, classify the extracted words in descending order of frequency, and generate a merging possibility signal and transmit the merging possibility signal to the user terminal when words at a set ranking or higher overlap between the two document images by a set ratio or more,
wherein the merging impossibility signal transmission unit generates the merging impossibility signal and transmits the merging impossibility signal to the user terminal when the words at the set ranking or higher overlap between the two document images by less than the set ratio.

5. The device of claim 4, further comprising:
a preceding-and-following relationship determination unit configured to extract phrases or words representing time points from paragraphs of each of the first document image and the second document image when the merging possibility signal is generated, and determine a temporal preceding-and-following relationship of the first document image and the second document image from the extracted phrases or words;
a title paragraph determination unit configured to determine the title paragraph of a document image of a following time point between the first document image and the second document image as a title paragraph of the merged new document on the basis of the preceding-and-following relationship determined by the preceding-and-following relationship determination unit; and
a subtitle paragraph determination unit configured to determine the title paragraph of a document image of a preceding time point between the first document image and the second document image as a subtitle paragraph of the merged new document on the basis of the preceding-and-following relationship determined by the preceding-and-following relationship determination unit,
wherein the preceding-and-following relationship determination unit determines the temporal preceding-and-following relationship by applying an AI model that learns document data including phrases, conjunctions, and words representing time points to the paragraphs of each of the first document image and the second document image.

6. The device of claim 5, further comprising:
an introductory paragraph determination unit configured to determine an introductory paragraph of the merged new document by connecting the introductory paragraph of the document image of the preceding time point between the first document image and the second document image and the introductory paragraph of the document image of the following time point on the basis of the preceding-and-following relationship determined by the preceding-and-following relationship determination unit;
a body paragraph determination unit configured to determine a body paragraph of the merged new document by connecting the body paragraph of the document image of the preceding time point between the first document image and the second document image and the body paragraph of the document image of the following time point on the basis of the preceding-and-following relationship determined by the preceding-and-following relationship determination unit; and
a conclusive paragraph determination unit configured to determine the conclusive paragraph of the document image of the following time point as a conclusive paragraph of the merged new document on the basis of the preceding-and-following relationship determined by the preceding-and-following relationship determination unit,
wherein the body paragraph determination unit determines a connective phrase of the body paragraph of the first document image and the body paragraph of the second document through an AI model that learns data of a plurality of sentences connected in a causal relationship and connects the two paragraphs using the determined connective phrase.

7. The device of claim 6, further comprising:
a sentence deletion unit configured to specify subjects, objects, and predicates of sentences included in the introductory paragraphs and body paragraphs determined by the introductory paragraph determination unit and the body paragraph determination unit, and when a plurality of sentences have specific similar subjects, objects, and predicates, delete the plurality of sentences except for a sentence with a longest length of characters; and
a new document data transmission unit configured to generate new document data in which the first document image and the second document image are merged by merging the paragraphs determined by the title paragraph determination unit, the subtitle paragraph determination unit, the introductory paragraph determination unit, the body paragraph determination unit, the conclusive paragraph determination unit, and the sentence deletion unit, distinguishably mark sentences generated from the first document image and characters generated from the second document image in the generated new document data, and transmit the generated new document data to the user terminal.
